(19) United States
(12) Patent Application Publication
(10) Pub. No.: US 2014/0002392 A1
(43) Pub. Date: Jan. 2, 2014

(54) METHOD FOR CONTROLLING AN ELECTRONIC APPARATUS AND AN ELECTRONIC APPARATUS

(71) Applicants: Beijing Lenovo Software Ltd., Beijing (CN); Lenovo (Beijing) Co., Ltd., Beijing (CN)

(72) Inventors: Xiaoqing XU, Beijing (CN); Yingbo ZHANG, Beijing (CN)

(21) Appl. No.: 13/924,328

(22) Filed: Jun. 21, 2013

(30) Foreign Application Priority Data
Jun. 29, 2012 (CN) 201210226517.3

(51) Int. Cl. G06F 3/041

(52) U.S. Cl. CPC G06F 3/041
USPC 345/173

(57) ABSTRACT

This application discloses a method for controlling an electronic apparatus and the electronic apparatus. The method for controlling the electronic apparatus is applied to a first electronic apparatus including a touch control screen. This electronic apparatus is capable to connect to at least one display screen, the method comprises: detecting whether there is a first touch control operation in the first region of the touch control screen; detecting to obtain a working mode of the touch control screen when there is the first touch control operation; generating a first control instruction based on the first touch control operation when the working mode is a first extended working mode, the second display screen corresponding to the the first extended working mode in at least one display screen being capable to obtain and display a first execution result.

### CROSS REFERENCE TO RELATED APPLICATIONS

This application claims the benefit under 35 U.S.C. §119(a) of Chinese Patent Application No. CN 201210226517.3, filed on Jun. 29, 2012, the entire disclosure of which is incorporated by reference herein in its entirety.

### BACKGROUND

The present invention relates to the field of electronic technology and in particular, to a method for controlling an electronic apparatus and an electronic apparatus.

With the development of electronic technologies, more and more electronic apparatus appear in the everyday lives of humans, for example tablet PCs, mobile phones, integrated machines, or the like.

When an electronic apparatus is used, the electronic apparatus may connect with a second display screen, and the file on the electronic apparatus can be dragged onto the second display screen to display in an extended mode. For example, a WORD document on the electronic apparatus is dragged onto the second display screen to display and other content is displayed on the electronic apparatus.

If the display screen of the electronic apparatus is a touch control screen, the file on the electronic apparatus can be operated by a touch control operation on the touch control screen, and if the file displayed on the second display screen is intended to be controlled, the second display screen connects to an external input device, for example, a mouse, a keyboard, or the like.

The inventor of this application found at least the following technical problems in the prior arts in the procedure of implementing the technical solutions of the embodiments of this application:

Since the content displayed on the second display screen cannot be operated directly by the operation to the touch control screen of the electronic apparatus in the prior arts, there are technical problems showing that the operation to the second display screen is inconvenient.

### SUMMARY

The embodiment of the present invention provides a method for controlling an electronic apparatus and an electronic apparatus that solves the technical problems of the inconvenient operation in the prior arts.

On one hand, this application provides the following technical solutions by an embodiment of this application.

A method for controlling an electronic apparatus, the method being applied in a first electronic apparatus, including a touch control screen and being able to connect to at least one display screen, the method comprising detecting whether there is a first touch control operation on a first region of the touch control screen; detecting to obtain a working mode of the touch control screen when there is the first touch control operation; and generating a first control instruction based on the first touch control operation when the working mode is a first extended working mode, and a second display screen corresponding to the first extended working mode in at least one display screen being able to obtain and display a first execution result by executing the first control instruction.

In one embodiment, detecting to obtain the working mode of the touch control screen specifically comprises: detecting to obtain a connecting type of N input/output interfaces to the electronic apparatus, wherein, N is an integer greater than or equal to 1; and determining the working mode of the touch control screen is the first extended working mode at the time of the first connecting type based on a first correspondence relation between the connecting type and the working mode.

In one embodiment, detecting to obtain the working mode of the touch control screen specifically comprises: detecting a first operation to a first application on the electronic apparatus; and determining the working mode of the touch control screen is the first extended working mode at the time of operating, as the first operation based on a second correspondence relation between the operation and the working mode.

In one embodiment, generating the first control instruction based on the first touch control operation specifically comprises: determining region information of a second region on the second display screen corresponding to the first region based on the first touch control operation; and generating the first control instruction based on the region information of the second region and the first touch control operation.

In one embodiment, generating the first control instruction based on the first touch control operation specifically comprises: determining a second region on the second display screen corresponding to the first region based on the first touch control operation; and sending the region information of the second region and the operational information of the first touch control operation to the second display screen to generate the first control instruction based on the second display screen.

In one embodiment, after detecting to obtain the working mode of the touch control screen when there is the first touch control operation, the method further comprises displaying the content displayed on the second display screen at a preset transparency value on the touch control screen when the working mode is the first extended working mode.

On the other hand, this application provides the following technical solutions by another embodiment of this application.

An electronic apparatus comprising a touch control screen and being able to connect to at least one display screen, characterized in that the electronic apparatus further comprises: a first detecting module for detecting whether there is a first touch control operation on a first region of the touch control screen; a second detecting module for detecting to obtain a working mode of the touch control screen when there is a first touch control operation; and an executing module for generating a first control instruction based on the first touch control operation, when the working mode is a first extended working mode, and a second display screen corresponding to the first extended working mode in at least one display screen being able to obtain and display a first execution result by executing the first control instruction.

In one embodiment, the second detecting module specifically comprises: a first detecting unit for detecting to obtain a connecting type of N input/output interfaces to the electronic apparatus, wherein, N is an integer greater than or equal to 1; and a first determining unit for determining the working mode of the touch control screen is the first extended working mode at the time of the first connecting type based on a first correspondence relation between the connecting type and the working mode.

In one embodiment, the second detecting module specifically comprises: a second detecting unit for detecting a first operation to a first application on the electronic apparatus; and a second determining unit for determining the working mode of the touch control screen is the first extended working mode at the time of operating as the first operation based on a second correspondence relation between the operation and the working mode.

In one embodiment, the executing module specifically comprises: a third determining unit for determining region information of a second region on the second display screen corresponding to the first region based on the first touch control operation; and a first generating unit for generating the first control instruction based on the region information of the second region and the first touch control operation.

In one embodiment, the executing module specifically comprises: a fourth determining unit for determining the second region on the second display screen corresponding to the first region based on the first touch control operation; and a second generating unit for sending the region information of the second region, and the operational information of the first touch control operation to the second display screen to generate the first control instruction based on the second display screen.

In one embodiment, the electronic apparatus further comprises: a displaying module for displaying the content displayed on the second display screen at a preset transparency value on the touch control screen when the working mode is the first extended working mode after detecting to obtain the working mode of the touch control screen when there is the first touch control operation.

One or more technical solutions provided by the embodiments of this application at least have the following technical effects or advantages:

(1) Since the file displayed on the second display screen can be operated based on the operation to the touch control screen of the electronic apparatus in the embodiments of this application, it has a more convenient operation to improve the experience of the user.

(2) Since the corresponding working mode of the electronic apparatus under different connecting types can be determined rapidly based on the correspondence relation of the connecting type and the working mode in the embodiments of this application, it obtains a technical effect of implementing a switch of the working mode of the electronic apparatus simply and rapidly.

(3) Since different working modes of the electronic apparatus can be triggered based on different operations to the first application of the electronic apparatus in the embodiments of this application, it does not need to improve the hardware of the electronic apparatus, to obtain the technical effect of saving resource.

(4) Since the region information of the second region on the second display screen corresponding to the first region can be determined based on the first touch control operation on the touch control screen of the electronic apparatus and a first control instruction of the operation to the second display screen can be generated in the embodiments of this application, it obtains a technical effect of higher control accuracy.

(5) Since the first control instruction can be generated at the electronic apparatus side without any improvement to the circuit at the display screen side in the embodiments of this application, it obtains a technical effect of convenient and easy operation.

(6) Since the first control instruction can be generated at the display screen side and there only needs a unified management on the display screen side without generating the first control instruction in the embodiments of this application, the electronic apparatus has a stronger and more convenient logic of management.

(7) Since the content displayed on the second display screen can be displayed at a preset transparency value on the touch control screen when the electronic apparatus is in an extended working mode in the embodiments of this application, the operation to the content of the second display screen is more convenient, and the possibility of misoperation is reduced.

### BRIEF DESCRIPTION OF THE DRAWINGS

FIG. 1 is a flow chart of the method for controlling the electronic apparatus in the first embodiment of this application;

FIG. 2 is a flow chart of determining the working mode of the electronic apparatus adopting a first manner in the first embodiment of this application;

FIG. 3 is a schematic diagram of the connection of the input/output interface(s) to the electronic apparatus in the first embodiment of this application;

FIG. 4 is a flow chart of determining the working mode of the electronic apparatus adopting a second manner in the first embodiment of this application;

FIG. 5 is a block view of the electronic apparatus in a second embodiment of this application.

### DETAILED DESCRIPTION

The embodiments of this application solve the technical problems of the inconvenient operation to the second display screen in the prior arts by providing a method for controlling the electronic apparatus and the electronic apparatus, to obtain a technical effect of more convenient operation to the second display screen effectively.

The technical solutions of the embodiments of this application have an overall idea as follows for solving the above problems:

When an electronic apparatus including a touch control screen is connected with at least one display screen, whether there is a first touch control operation on a first region of the touch control screen, for example, a click operation on the first location on the touch control screen is detected:

When there is the first touch control operation, a working mode of the touch control screen is detected to obtain, the manners for detection comprises various manners, for example, the connecting type of the GPIO interface of the electronic apparatus, the operation of user to a certain application or the like;

When the working mode is determined as a first extended working mode, a first control instruction is generated based on the first touch control operation, and a second display screen corresponding to the first extended working mode in the at least one display screen is able to obtain and display a first execution result by executing the first control instruction.

For understanding the above-described technical solutions better, the above-described technical solutions are explained in detail in combination with the accompanying drawings of the specification and the specific implementation modes.

### First Embodiment

A first embodiment of this application provides a method for controlling the electronic apparatus applied in the electronic apparatus including a touch control screen, the electronic apparatus is connected with at least one display screen. Wherein, the electronic apparatus may be a notebook computer, a tablet computer, a mobile phone, or the like, the display screen may be a separate display screen, and may be an electronic apparatus with a display screen, in the specific implementation procedure. This application does not make any limitations to the kinds of electronic apparatus and the kinds of display screens.

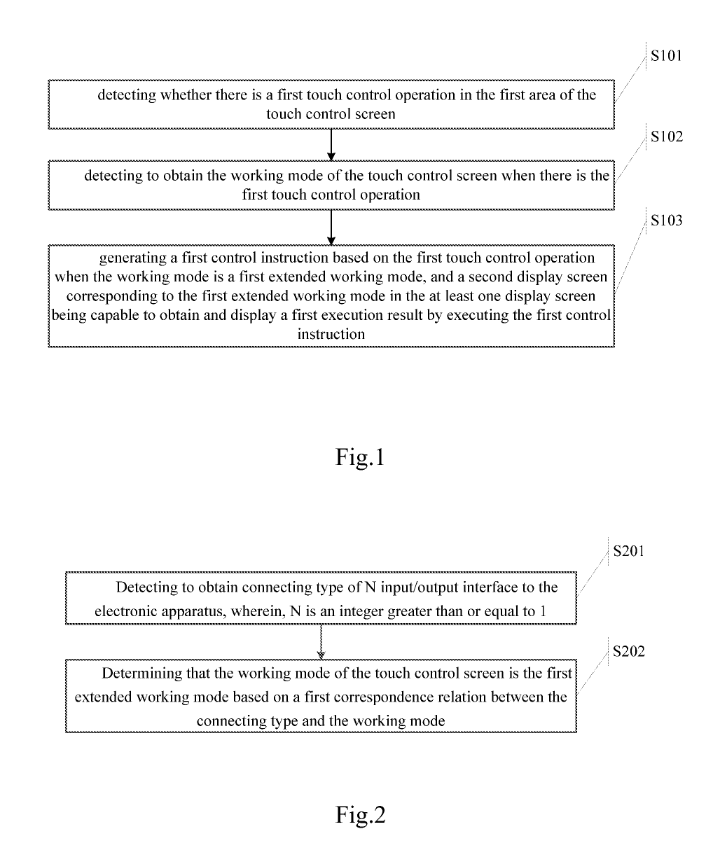

As shown in FIG. 1, the method for controlling the electronic apparatus comprises the following steps:

S101: detecting whether there is a first touch control operation on a first region of the touch control screen;

In the specific implementation procedure, the first touch control operation may be any touch control operation on the touch control screen, for example, a click operation, a double click operation, a slide operation, or the like. This application does not make any limitations to the kinds of first touch control operations in the specific implementation procedure.

After whether there is the first touch control operation is detected in the step S101, the step S102 is executed, i.e., detecting to obtain the working mode of the touch control screen when there is the first touch control operation.

In the specific implementation procedure, the working mode of the touch control screen can be detected by various manners, two kinds of detecting manners among them is listed as follows to be described in detail, of course, it is not limited to the following two kinds of instances in the specific implementation procedure.

First, N input/output interfaces are provided on the electronic apparatus, as shown in FIG. 2, the working mode of the the electronic apparatus is determined by the following manners.

S201: detecting to obtain the connecting type of the N input/output interfaces to the electronic apparatus, wherein, N is a integer greater than or equal to 1;

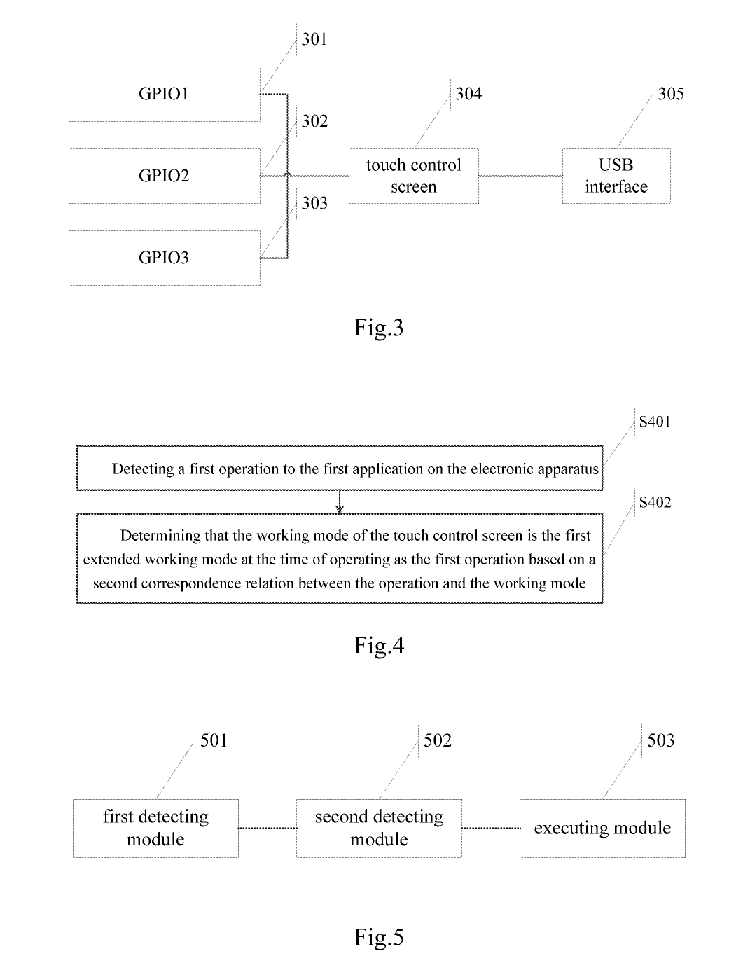

For example, as shown in FIG. 3, the touch control screen 304 of the electronic apparatus is connected with three input/output interfaces, which are GPIO 1301, GPIO 2302, and GPIO 3303 respectively, wherein, there are eight connecting types in all, which are 000, 001, 010, 011, 100, 101, 110, and 111 respectively. That is, the electronic apparatus may comprise eight working modes, which consist of one normal working mode and seven extended working modes, respectively. Then, a first correspondence relation can be established between the working modes and the connecting types, that is, each working mode of the eight working modes corresponds to a different connecting type of the input/output interface, respectively. Then, when the touch control screen 304 is connected to the electronic apparatus through a USB interface 305, the working mode of the touch control screen 304 of the electronic apparatus can be determined based on the first correspondence relation.

After detecting the connecting types of the N input/output interfaces and the electronic apparatus based on the step S201, the step S202 can be executed. That is, the working mode of the touch control screen being the first extended working mode is determined at the time of the first connecting type based on the first correspondence relation between the connecting type and the working mode.

For example, in the step S201, the electronic apparatus comprises one normal working mode and seven extended working mode, and if the electronic apparatus is connected with seven display screens, wherein the correspondence relation among the connecting type, the working mode and the concrete operation are as follow:

| Connecting | | |
|---|---|---|
| type | Working mode | Concrete operation |
| 000 | Normal mode | Electronic apparatus |
| 001 | First extended working mode | Second display screen |
| 010 | Second extended working mode | Third display screen |
| 011 | Third extended working mode | Fourth display screen |
| 100 | Fourth extended working mode | Fifth display screen |
| 101 | Fifth extended working mode | Sixth display screen |
| 110 | Sixth extended working mode | Seventh display screen |
| 111 | Seventh extended working mode | Eighth display screen |

Therefore, when the connecting type is 001, it determines that the working mode of the electronic apparatus is the first extended mode based on the first correspondence relation, and it indicates that the file displayed on the second display screen can be operated.

It can be understood from the above description that, since the corresponding working mode of the electronic apparatus under different connecting types can be determined rapidly based on the correspondence relation of the connecting type and the working mode in the embodiments of this application, it obtains a technical effect of implementing a switch of the working mode of the electronic apparatus simply and rapidly.

Second, different applications are set corresponding to the working mode of the electronic apparatus. As shown in FIG. 4, the working mode of the electronic apparatus is determined by adopting the following manners.

S401: detecting a first operation to the first application on the electronic apparatus.

For example, a plurality of keys is provided to the first application, when a click operation is carried out to the first key, it indicates a first operation, when a click operation is carried out to the second key, it indicates a second operation, and so on. The first operation can be any operation but not limited to the above instance in the specific implementation procedure.

After obtaining the first operation based on the step S401, the step S402 can be executed. That is, it determines that the working mode of the touch control screen is the first extended working mode at the time of operating as the first operation based on the second correspondence relation between the operation and the working mode.

Of course, in the specific implementation procedure, different keys of the same application may correspond to different working modes of the electronic apparatus, and it can set a plurality of applications each corresponding to one working mode, this application does not make a limitation to how the application corresponds to the working mode of the electronic apparatus in the specific implementation procedure.

It can be understood from the above description that, since different working modes of the electronic apparatus can be triggered based on different operations to the first application of the electronic apparatus in the embodiments of this application, it does not need to improve the hardware of the electronic apparatus, to obtain the technical effect of saving resource.

S103, generating a first control instruction based on the first touch control operation when the working mode is the first extended working mode, and a second display screen corresponding to the first extended working mode in the at least one display screen being able to obtain and display a first execution result by executing the first control instruction.

In the specific implementation procedure, the procedure of generating the first control instruction based on the first touch control operation can be carried out on any electronic apparatus, this procedure is described in case of generating the first control instruction at the electronic apparatus side and the display screen side hereinafter, of course, in the specific implementation procedure, it is not limited to the following two kinds of instances.

First, the first control instruction is generated at the electronic apparatus side.

In the specific implementation procedure, generating the first control instruction based on the first touch control operation specifically comprises:

Determining region information of a second region on the second display screen corresponding to the first region based on the first touch control operation.

For example, if the size of the touch control screen of the electronic apparatus is ten inches, and the size of the first electronic apparatus is twenty inches, it assumes that the coordinates of the four pixel points of the first region on the touch control screen are: (10, 10), (15, 10), (10, 15), and (15, 15). Since the size of the second display screen is two times the touch control screen, the coordinates of the four pixel points of the second region of the second display screen corresponding to the first region should be: (20, 20), (30, 20), (20, 30), and (30, 30).

Generating the first control instruction based on the region information of the second region and the first touch control operation.

For example, the operation at the first region is a click operation, so that a click instruction on the second region is generated, then the click instruction is sent to the second display screen, at this time, if the second region of the second display corresponds to a button, then the click operation is the operation of clicking the button or the like.

It can be understood from the above description that, since the first control instruction can be generated at the electronic apparatus side without any improvement to the circuit at the display screen side in the embodiments of this application, it obtains a technical effect of convenient and easy operation.

Second, the first control instruction is generated at the display screen side.

In the specific implementation procedure, generating the first control instruction based on the first touch control operation specifically comprises:

Determining the second region on the second display screen corresponding to the first region based on the first touch control operation;

Sending the region information of the second region and the operational information of the first touch control operation to the second display screen to generate the first control instruction based on the second display screen.

In particular, instead of generating the first control instruction on the electronic apparatus, the information of the first operation (for example, a click operation, a double click operation or a slide operation, or the like) and the region information of the second region corresponding to the first operation is sent to the second display screen, then the corresponding first control instruction is generated on the second display screen to carry out the touch control operation to the second display screen. Of course, in the specific implementation procedure, the information of the first region can be sent directly to the second display screen, then the region information of the second region is obtained based on the second display screen. This application does not make a limitation on how to obtain the region information of the second region in the specific implementation procedure.

It can be understood from the above description that since the first control instruction can be generated at the display screen side so that there only needs a unified management on the display screen side without generating the first control instruction in the embodiments of this application, so the electronic apparatus have a technical effect of a stronger logic of management and more convenient management of the electronic apparatus.

And also, since the region information of the second region on the second display screen corresponding to the first region can be determined based on the first touch control operation on the touch control screen of the electronic apparatus and a first control instruction of the operation to the second display screen can be generated in the embodiments of this application, it obtains a technical effect of higher control accuracy.

In the specific implementation procedure, when the electronic apparatus is in the first extended working mode, that is, a touch control operation is carried out to the second display screen based on the touch control screen of the electronic apparatus, the content displayed by the second display screen can further be displayed at a preset transparency value on the touch control screen.

For example, user A is carrying out a lecture by slide show using an electronic apparatus and the second display screen, wherein, the lecture document is displayed on the touch control screen of the electronic apparatus, and the slide is displayed on the second display screen. In order for user A to see the content of the lecture document and operate the slide accurately, the content of the slide can be displayed at a preset transparency value (for example, 30%, 20%) while the lecture document is displayed on the touch control screen. Of course, the preset transparency value can be any value and not limited to the above instance in the specific implementation procedure.

Further, in the specific implementation procedure, if the electronic apparatus is connected with a plurality of display screens, different contents can be displayed on the touch control screen based on the working modes of the electronic apparatus, for example, if the electronic apparatus is in the first extended working mode, then the content on the second display screen is displayed at a preset transparency on the touch control screen; and if the electronic apparatus is in the second extended working mode, then the content on the third display screen is displayed at a preset transparency on the touch control screen, and so on. This application does not make any limitations.

It can be understood from the above description that, since the content displayed on the second display screen can be displayed at a preset transparency value on the touch control screen when the electronic apparatus is in an extended working mode in the embodiments of this application, the operation to the content of the second display screen is more convenient, and the possibility of misoperation is reduced.

### Second Embodiment

A second embodiment of this application provides an electronic apparatus including a touch control screen, the electronic apparatus is capable to connect to at least one display screen. Wherein, the electronic apparatus may be a notebook computer, a tablet computer, a mobile phone, or the like, the display screen may be a separate display screen and may be an electronic apparatus with a display screen in the specific implementation procedure. This application does not make any limitations to the kinds of electronic apparatus and the kinds of display screens.

As shown in FIG. 5, the electronic apparatus further comprises the following structures:

A first detecting module 501 for detecting whether there is a first touch control operation on the first region of the touch control screen;

In the specific implementation procedure, the first touch control operation may be any touch control operation on the touch control screen, for example, a click operation, a double click operation, a slide operation, or the like. This application does not make any limitations to the kinds of first touch control operations in the specific implementation procedure.

A second detecting module 502 for detecting to obtain the working mode of the touch control screen when there is the first touch control operation.

In the specific implementation procedure, the second detecting module 502 may comprise different functional modules, and then detect the working modes of the touch control screen by adopting different manners, hereinafter a list of two kinds of functional modules are introduced. Of course, it is not limited to the following kinds of instances in the specific implementation procedure.

First, N input/output interfaces are provided on the electronic apparatus, then the second detecting module 502 specifically comprises:

A first detecting unit for detecting to obtain the connecting type of N input/output interfaces to the electronic apparatus, wherein, N is an integer greater than or equal to 1;

A first determining unit for determining the working mode of the touch control screen is the first extended working mode at the time of the first connecting type based on a first correspondence relation between the connecting type and the working mode.

It can be understood from the above description that, since the corresponding working mode of the electronic apparatus under different connecting types can be determined rapidly based on the correspondence relation of the connecting type and the working mode in the embodiments of this application, it obtains a technical effect of implementing a switch of the working mode of the electronic apparatus simply and rapidly.

Second, different applications are set corresponding to the working modes of the electronic apparatus. Then the second detecting module 502 specifically comprises:

A second detecting unit for detecting a first operation to the first application on the electronic apparatus;

A second determining unit for determining the working mode of the touch control screen is the first extended working mode at the time of operating as the first operation based on a second correspondence relation between the operation and the working mode.

For example, a plurality of keys is provided to the first application, when a click operation is carried out to the first key, it indicates a first operation, when a click operation is carried out to the second keys, it indicates a second operation, and so on, of course, the first operational can be any operation but not limited to the above instance in the specific implementation procedure.

Of course, in the specific implementation procedure, different keys of the same application may correspond to different working modes of the electronic apparatus, and it can set a plurality of applications each corresponding to one working mode, this application does not make an limitation to how the application corresponds to the working mode of the electronic apparatus in the specific implementation procedure.

It can be understood from the above description that, since different working modes of the electronic apparatus can be triggered based on different operations to the first application of the electronic apparatus in the embodiments of this application, it does not need to improve the hardware of the electronic apparatus, to obtain the technical effect of saving resource.

An executing module 503 for generating a first control instruction based on the first touch control operation when the working mode is a first extended working mode, and a second display screen corresponding to the first extended working mode in the at least one display screen being capable to obtain and display a first execution result by executing the first control instruction.

In the specific implementation procedure, the procedure of generating the first control instruction based on the first touch control operation may be carried out on any electronic apparatus, so that the functions of the execution module 503 are different. Hereinafter it is introduced by taking the first control instruction being generated on the electronic apparatus side and the display screen side as example. Of course, there is not a limit to the following kinds of instances in the specific implementation procedure.

First, the first control instruction is generated at the electronic apparatus side. Then, in the specific implementation procedure, the executing module 503 specifically comprises:

A third determining unit for determining region information of the second region on the second display screen corresponding to the first region based on the first touch control operation;

A first generating unit for generating the first control instruction based on the region information of the second region and the first touch control operation.

For example, if the size of the touch control screen of the electronic apparatus is ten inches, and the size of the first electronic apparatus is twenty inches, it assumes that the coordinates of the four pixel points of the first region on the touch control screen are: (10, 10), (15, 10), (10, 15), and (15, 15). Since the size of the second display screen is two times the touch control screen, the coordinates of the four pixel points of the second region of the second display screen corresponding to the first region should be: (20, 20), (30, 20), (20, 30), and (30, 30).

The first control instruction is generated based on the region information of the second region and the first touch control operation.

For example, the operation at the first region is a click operation, so that a click instruction on the second region is generated, then the click instruction is sent to the second display screen, at this time, if the second region of the second display corresponds to a button, then the click operation is the operation of clicking the button or the like.

It can be understood from the above description that, since the first control instruction can be generated at the electronic apparatus side without any improvement to the circuit at the display screen side in the embodiments of this application, it obtains a technical effect of convenient and easy operation.

Second, the first control instruction is generated at the display screen side. Then, the executing module 503 specifically comprises:

A fourth determining unit for determining the second region on the second display screen corresponding to the first region based on the first touch control operation;

A second generating unit for sending the region information of the second region and the operational information of the first touch control operation to the second display screen to generate the first control instruction based on the second display screen.

In particular, instead of generating the first control instruction on the electronic apparatus, the information of the first operation (for example, a click operation, a double click operation or a slide operation, or the like) and the region information of the second region corresponding to the first operation is sent to the second display screen, then the corresponding first control instruction is generated on the second display screen to carry out the touch control operation to the second display screen. Of course, in the specific implementation procedure, the information of the first region can be sent directly to the second display screen, then the region information of the second region is obtained based on the second display screen. This application does not make limitation on how to obtain the region information of the second region in the specific implementation procedure.

It can be understood from the above description that since the first control instruction can be generated at the display screen side so that there only needs a unified management on the display screen side without generating the first control instruction in the embodiments of this application, so the electronic apparatus have a technical effect of a stronger logic of management and more convenient management of the electronic apparatus.

And also, since the region information of the second region on the second display screen corresponding to the first region can be determined based on the first touch control operation on the touch control screen of the electronic apparatus and a first control instruction of the operation to the second display screen can be generated in the embodiments of this application, it obtains a technical effect of higher control accuracy.

In the specific implementation procedure, the electronic apparatus further comprises:

A displaying module for displaying the content displayed on the second display screen at a preset transparency value on the touch control screen when the working mode is the first extended working mode after detecting to obtain the working mode of the touch control screen when there is the first touch control operation.

For example, user A is carrying out a lecture by slide show using an electronic apparatus and the second display screen, wherein, the lecture document is displayed on the touch control screen of the electronic apparatus, and the slide is displayed on the second display screen, in order for the user A to see the content of the lecture document and operate the slide accurately, the content of the slide can be displayed at a preset transparency value (for example, 30%, 20%) while the lecture document is displayed on the touch control screen, of course, the preset transparency value can be any value but not limited to the above instance in the specific implementation procedure.

Further, in the specific implementation procedure, if the electronic apparatus is connected with a plurality of display screens, different contents can be displayed on the touch control screen based on the working modes of the electronic apparatus, for example, if the electronic apparatus is in the first extended working mode, then the content on the second display screen is displayed at a preset transparency on the touch control screen; and if the electronic apparatus is in the second extended working mode, then the content on the third display screen is displayed at a preset transparency on the touch control screen, and so on. This application does not make any limitations.

It can be understood from the above description that, since the content displayed on the second display screen can be displayed at a preset transparency value on the touch control screen when the electronic apparatus is in an extended working mode in the embodiments of this application, the operation to the content of the second display screen is more convenient, and the possibility of misoperation is reduced.

Since the electronic apparatus introduced in the embodiment 2 of this application is the electronic apparatus adopted by the method of the embodiment 1 of this application, those skilled in the art can understand the detailed implementation of the electronic apparatus of the second embodiment of this application and the various variations thereof, so the electronic apparatus is no longer described in detail here. The electronic apparatus adopted by those skilled in the art implementing the method of the first embodiment of this application all fall into the scope sought for protection of this application.

One or more technical solutions provided by the embodiments of this application at least have the following technical effects or advantages:

(1) Since the file displayed on the second display screen can be operated based on the operation to the touch control screen of the electronic apparatus in the embodiments of this application, it obtains a technical effect of more convenient operation, to improve the experience of the user.

(2) Since the corresponding working mode of the electronic apparatus under different connecting types can be determined rapidly based on the correspondence relation of the connecting types and the working modes in the embodiments of this application, it obtains a technical effect of implementing a switch of the working mode of the electronic apparatus simply and rapidly.

(3) Since different working modes of the electronic apparatus can be triggered based on different operations to the first application of the electronic apparatus in the embodiments of this application, it does not need to improve the hardware of the electronic apparatus, to obtain the technical effect of saving resource.

(4) Since the region information of the second region on the second display screen corresponding to the first region can be determined based on the first touch control operation on the touch control screen of the electronic apparatus and a first control instruction of the operation to the second display screen can be generated in the embodiments of this application, it obtains a technical effect of higher control accuracy.

(5) Since the first control instruction can be generated at the electronic apparatus side without any improvement to the circuit at the display screen side in the embodiments of this application, it obtains a technical effect of convenient and easy operation.

(6) Since the first control instruction can be generated at the display screen side and there only needs a unified management on the display screen side without generating the first control instruction in the embodiments of this application, the electronic apparatus have a technical effect of a stronger and more convenient logic of management.

(7) Since the content displayed on the second display screen can be displayed at a preset transparency value on the touch control screen when the electronic apparatus is in an extended working mode in the embodiments of this application, the operation to the content of the second display screen is more convenient, and the possibility of misoperation is reduced.

Though the preferred embodiments of the present invention are described, those skilled in the art can make additional alterations and modifications to these embodiments in case of knowing the basic creative concepts. Therefore, the appended claims intend to be defined as including the preferable embodiments as well as all of the alterations and modifications falling into the scope of the present invention.

It is obvious that those skilled in the art can make any modifications and variations to the present invention without departing from the spirits and scopes of the present invention.

Thus, if these modifications and variations of the present invention fall within the scope of the claims of the present invention and the equivalent technology, the present invention intends to comprise these modifications and variations.

What is claimed is:

1. A method for controlling an electronic apparatus, the method being applied in a first electronic apparatus including a touch control screen and able to connect to at least one display screen, which is characterized in that the method comprises:
detecting whether there is a first touch control operation on a first region of the touch control screen;
detecting to obtain a working mode of the touch control screen when there is the first touch control operation; and
when the working mode is a first extended working mode, generating a first control instruction based on the first touch control operation, and a second display screen corresponding to the first extended working mode in the at least one display screen being able to obtain and display a first execution result by executing the first control instruction.

2. The method according to claim 1, which is characterized in that, detecting to obtain the working mode of the touch control screen specifically comprises:
detecting to obtain a connecting type of N input/output interfaces to the electronic apparatus, wherein, N is a integer greater than or equal to 1; and
determining the working mode of the touch control screen is the first extended working mode based on a first correspondence relation between the connecting type and the working mode.

3. The method according to claim 1, which is characterized in that, detecting to obtain the working mode of the touch control screen specifically comprises:
detecting a first operation to the first application on the electronic apparatus; and
determining the working mode of the touch control screen is the first extended working mode at the time of operating as the first operation based on a second correspondence relation between the operation and the working mode.

4. The method according to claim 1, which is characterized in that, generating the first control instruction based on the first touch control operation specifically comprises:
determining region information of a second region on the second display screen corresponding to the first region based on the first touch control operation; and
generating the first control instruction based on the region information of the second region and the first touch control operation.

5. The method according to claim 1, which is characterized in that, generating the first control instruction based on the first touch control operation specifically comprises:
determining the second region on the second display screen corresponding to the first region based on the first touch control operation; and
sending the region information of the second region and the operational information of the first touch control operation to the second display screen to generate the first control instruction based on the second display screen.

6. The method according to claim 1, which is characterized in that, after detecting to obtain the working mode of the touch control screen when there is the first touch control operation, the method further comprises:
displaying the content displayed on the second display screen at a preset transparency value on the touch control screen when the working mode is the first extended working mode.

7. An electronic apparatus comprising a touch control screen and being capable to connect to at least one display screen, which is characterized in that the electronic apparatus further comprises:
a first detecting module for detecting whether there is a first touch control operation on a first region of the touch control screen;
a second detecting module for detecting to obtain a working mode of the touch control screen when there is the first touch control operation; and
an executing module for generating a first control instruction based on the first touch control operation when the working mode is a first extended working mode, and a second display screen corresponding to the first extended working mode in the at least one display screen being capable to obtain and display a first execution result by executing the first control instruction.

8. The electronic apparatus according to claim 7, which is characterized in that, the second detecting module specifically comprises:
a first detecting unit for detecting to obtain the connecting type of N input/output interfaces to the electronic apparatus, wherein, N is an integer greater than or equal to 1; and
a first determining unit for determining the working mode of the touch control screen is the first extended working mode at the time of the first connecting type based on a first correspondence relation between the connecting type and the working mode.

9. The electronic apparatus according to claim 7, which is characterized in that, the second detecting module specifically comprises:
a second detecting unit for detecting a first operation to the first application on the electronic apparatus; and
a second determining unit for determining the working mode of the touch control screen is the first extended working mode at the time of operating as the first operation based on a second correspondence relation between the operation and the working mode.

10. The electronic apparatus according to claim 7, which is characterized in that, the executing module specifically comprises:
a third determining unit for determining region information of a second region on the second display screen corresponding to the first region based on the first touch control operation; and
a first generating unit for generating the first control instruction based on the region information of the second region and the first touch control operation.

11. The electronic apparatus according to claim 7, which is characterized in that, the executing module specifically comprises:
a fourth determining unit for determining the second region on the second display screen corresponding to the first region based on the first touch control operation; and
a second generating unit for sending the region information of the second region and the operational information of the first touch control operation to the second display screen to generate the first control instruction based on the second display screen.

12. The electronic apparatus according to claim 7, which is characterized in that, the electronic apparatus further comprises:
a displaying module for displaying the content displayed on the second display screen at a preset transparency value on the touch control screen when the working mode is the first extended working mode after detecting to obtain the working mode of the touch control screen when there is the first touch control operation.
